(19) United States
(12) Patent Application Publication
(10) Pub. No.: US 2006/0041596 A1
(43) Pub. Date: Feb. 23, 2006

(54) Caching directory server data for controlling the disposition of multimedia data on a network

(76) Inventors: Vlad Stirbu, Tampere (FI); Kari Kaarela, Oulu (FI); Jose Costa-Requena, Helsinki (FI); Markku Tamski, Tampere (FI)

Correspondence Address: Hollingsworth & Funk, LLC;Suite 125, 8009 34th Avenue South, Minneapolis, MN, 55425, US

(21) Appl. No.: 11/029,027

(22) Filed: Jan. 3, 2005

Related U.S. Application Data
(60) Provisional application No. 60/603,021, filed on Aug. 19, 2004.

(51) Int. Cl. G06F 17/30

(52) U.S. Cl. 707/200

(57) ABSTRACT

Synchronizing content description data between devices on an ad hoc peer-to-peer network involves storing a plurality of data entries on a directory server. Each data entry describes one or more multimedia data objects accessible via the network. A synchronization object of the directory server is associated with the data entries. The synchronization object is capable of describing changes to the data entries. The data entries are downloaded from the directory server to a cache of a control point device via the network. The synchronization object of the directory server is changed in response to a change in at least one of the data entries of the directory server. The cache of the control point device is updated with the change in the at least one data entry based on the changing of the synchronization object of the directory server.

This application claims the benefit of U.S. Provisional Application No. 60/603,021, filed Aug. 19, 2004, the content of which is incorporated herein by reference in its entirety.

### FIELD OF THE INVENTION

This invention relates in general to communications, and more particularly to controlling multimedia data in a consumer electronics network environment.

### BACKGROUND OF THE INVENTION

Mobile communications devices such as cell phones are gaining wider acceptance due to the capabilities being added to such devices. Modern mobile technologies have become an important niche in the growing field of personal digital communications. Some mobile communications devices include features that allow the devices to communicate with computers and other consumer electronics devices. For example, a standard known as Universal Plug and Play™ (UPnP) provides a way for disparate processing devices to exchange data via a network. The UPnP standard defines an architecture for peer-to-peer network connectivity by a wide variety of electronic devices. The UPnP standard includes standards for service discovery, and is mainly targeted for proximity or ad hoc networks.

Various devices publish UPnP device and service descriptions, thus creating a way to easily connect devices and simplifying the implementation of networks. UPnP is designed to work in many environments, including the home, businesses, public spaces, and on devices attached to the Internet. The UPnP standard is an open architecture that leverages Web technologies and is designed to provide ad-hoc networking and distributed computing.

The UPnP model is designed to support zero-configuration networking and automatic discovery for a wide variety of device categories. This allows a device to dynamically join a network, obtain a network address, convey the device's capabilities, and learn about the presence and capabilities of other devices. Internet protocols such as Dynamic Host Configuration Protocol (DHCP) and Domain Name Service (DNS) may optionally included in a UPnP network, although they are not required.

The UPnP standard also includes an audio-video (AV) specification specifically targeted to Consumer Electronics (CE) devices such as TVs, VCRs, DVD players, stereo systems, MP3 players, and the like. Generally, a CE device refers to any device that interacts with multimedia content (e.g., movies, audio, and still images), and CE devices may include computers and mobile communications devices.

The UPnP AV framework defines three main logical entities: a Media Server, a Media Renderer, and an AV Control Point. The Media Server has access to multimedia content and can send that content to a Media Renderer device via a UPnP network. A Media Renderer is able render multimedia content received from the UPnP network. The AV Control Point coordinates operations of Media Servers and Media Renderers based on end-user requirements.

The AV Control Point is involved in command and control operations of the UPnP AV network. The Control Point accesses a Content Directory Service (CDS) to discover and enumerate content that is accessible via the Media Server. The content discoverable via the CDS may include individual pieces of content such as songs and video clips. The CDS content may also include containers, which represent collections of items such as playlists and photo albums. Each CDS content object, whether an item or container, includes metadata that describes various attributes of the object, such as title, artist, etc.

One advantage of a UPnP Media Server is that it can store multimedia collections in a central location, yet the content can be accessed by devices in different locations throughout the home due the distributed nature of the UPnP network. Therefore, a portable unit such as a mobile communications device makes an ideal control point for controlling the access to such data. In order for a mobile communications device to access data from one or more Media Servers, then the mobile communications device must communicate with a CDS.

It will be appreciated that a CDS may contain references to many thousands of content objects. The bandwidth consumed in accessing the CDS from a mobile device may be quite large if the mobile device must enumerate a large number of objects. Mobile communications devices typically have limited bandwidth compared to wired devices, thus the mobile device may exhibit poor usability and performance if required to repeatedly access this large amount of data. In order for mobile devices to control the disposition of multimedia content via UPnP or similar networks, it is desirable to provide a way to efficiently communicate content directory data between the mobile device and those network entities that provide the directory services.

### SUMMARY OF THE INVENTION

The present disclosure relates to a system, apparatus and method for controlling the disposition of multimedia data between devices on a network. In accordance with one embodiment of the invention, a method involves storing a plurality of data entries on a directory server. Each data entry describes one or more multimedia data objects accessible via the network. A synchronization object of the directory server is associated with the data entries. The synchronization object is capable of describing changes to the data entries. The data entries are downloaded from the directory server to a cache of a control point device via the network. The synchronization object of the directory server is changed in response to a change in at least one of the data entries of the directory server. The cache of the control point device is updated with the change in the at least one data entry based on the changing of the synchronization object of the directory server.

In a more particular embodiment, the method further involves modifying the synchronization object to reflect the updating of the cache of the control point device. In one configuration, the synchronization object may include a hash of the data entries. In other configurations, the synchronization object is capable of describing a change at least one of time stamp and signature associated with the multimedia data objects. In other configurations, the synchronization object is capable of describing the addition and deletion of an entry of the plurality of data entries.

In a more particular embodiment, changing the synchronization object of the directory server in response to the change in at least one of the data entries of the directory server involves adding data to the synchronization object. The added data describes the change in the at least one data entry. In other, more particular embodiments, changing the synchronization object may also involve creating a new synchronization object that describes the change and associating the new synchronization object with the entries. In these particular embodiments, updating the cache of the control point device may involve examining a plurality of new synchronization objects that were added after a previous update of the cache and before the current update of the cache.

In accordance with another embodiment of the present invention, an apparatus includes a network interface capable of communicating with a directory server via an ad hoc peer-to-peer network. A processor is coupled to the network interface and memory is coupled to the processor. The memory includes a cache capable of storing data and a control point module. The control point module has instructions that cause the processor to: download a plurality of data entries from the directory server to the cache via the network, each data entry describing one or more multimedia data objects accessible via the network; access, via the network, a synchronization object of the directory server associated with the data entries of the directory server, the synchronization object capable of describing changes to the data entries; detect a change in the synchronization object of the directory server, the change occurring in response to a change in at least one of the data entries of the directory server; and update the cache with the change in the at least one data entry based on the changing of the synchronization object of the directory server.

In accordance with another embodiment of the present invention, a computer-readable medium has stored instructions that are executable by a data processing arrangement capable of being coupled to an ad hoc, peer-to-peer network. The instructions are executable for performing steps that include: storing a plurality of data entries, each data entry describing one or more multimedia data objects that are accessible by a network entity via the network; communicating the data entries to the network entity; storing a synchronization object capable of describing changes to the data entries; changing the synchronization object in response to a change in at least one of the data entries; and communicating the change in the synchronization object to the network entity so that the network entity is able to update a cache of the data entries based on the change in the synchronization object.

In accordance with another embodiment of the present invention, an apparatus includes a network interface capable of communicating via an ad hoc peer-to-peer network. A processor is coupled to the network interface and memory is coupled to the processor. The memory includes a directory service module having instructions that cause the processor to: store a plurality of data entries, each data entry describing one or more multimedia data objects that are accessible by a network entity via the network; communicate the data entries to the network entity; associate a synchronization object with the data entries, the synchronization object capable of describing changes to the data entries; change the synchronization object in response to a change in at least one of the data entries associated with the synchronization object; and communicate the change in the synchronization object to the network entity so that the network entity is able to update a cache of the data entries based on the change in the synchronization object.

In accordance with another embodiment of the present invention, a computer-readable medium has stored instructions that are executable by a data processing arrangement capable of being coupled to an ad hoc, peer-to-peer network. The instructions are executable for performing steps that include: storing a plurality of data entries, each data entry describing one or more multimedia data objects that are accessible by a network entity via the network; communicating the data entries to the network entity; storing a synchronization object capable of describing changes to the data entries; changing the synchronization object in response to a change in at least one of the data entries; and communicating the change in the synchronization object to the network entity so that the network entity is able to update a cache of the data entries based on the change in the synchronization object.

In accordance with another embodiment of the present invention, a system includes an ad hoc, peer-to-peer network. A directory server is coupled to the network and configured to store a plurality of data entries on a data store. Each data entry describes one or more multimedia data objects accessible via the network. A synchronization object of the directory server is associated with the data entries. The synchronization object of the directory server is changed in response to a change the data entries. The system also includes a control point coupled to the network. The control point is configured to download the plurality of data entries from the directory server to a cache of the control point and detect the change in the synchronization object of the directory server. The control point updates the cache with the change in the at least one data entry based on the changing of the synchronization object of the directory server

In accordance with another embodiment of the present invention, an apparatus includes: means for storing a plurality of data entries downloaded from a directory server, each data entry describing one or more multimedia data objects accessible via a network; means for accessing a synchronization object of the directory server associated with the data entries of the directory server, the synchronization object capable of describing changes to the data entries of the directory server; means for detecting a change in the synchronization object of the directory server, the change occurring in response to a change in at least one of the data entries of the directory server; and means for updating the data entries stored on the apparatus with the change in the at least one data entry based on the changing of the synchronization object of the directory server.

In accordance with another embodiment of the present invention, an apparatus includes: means for storing a plurality of data entries downloaded from a directory server, each data entry describing one or more multimedia data objects accessible via a network; means for accessing a synchronization object of the directory server associated with the data entries of the directory server, the synchronization object capable of describing changes to the data entries of the directory server; means for detecting a change in the synchronization object of the directory server, the change occurring in response to a change in at least one of the data entries of the directory server; and means for updating the data entries stored on the apparatus with the change in the at least one data entry based on the changing of the synchronization object of the directory server.

In accordance with another embodiment of the present invention, a method involves storing a plurality of data entries on a directory server. Each data entry describes one or more multimedia data objects accessible via the network. A unique ID of the directory server is associated with at least one of the data entries. The data entries are downloaded from the directory server to a cache of a mobile terminal via the network. The unique ID of the directory server is changed in response to a change in at least one of the data entries associated with the unique ID. The cache of the mobile terminal is updated with the change in the at least one data entry based on the changing of the unique ID of the directory server.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system, apparatus, and method in accordance with the invention.

### BRIEF DESCRIPTION OF THE DRAWINGS

The invention is described in connection with the embodiments illustrated in the following diagrams.

FIG. 1 illustrates a Universal Plug and Play multimedia system according to embodiments of the present invention;

FIG. 2A illustrates a procedure for initially populating a directory server cache according to embodiments of the present invention;

FIG. 2B illustrates a procedure for recursively reading directory server containers for populating a directory server cache according to embodiments of the present invention;

FIG. 3 illustrates an arrangement of containers and objects stored on a directory server that may be used to track content directory changes according to embodiments of the present invention;

FIG. 4 illustrates a sequence of exchanges for using cache synchronization to backup media server data according to embodiments of the present invention; and

FIG. 5 illustrates a mobile terminal configured as a control point and media renderer according to embodiments of the present invention.

### DETAILED DESCRIPTION OF THE INVENTION

In the following description of various exemplary embodiments, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention provides a way of controlling the disposition of multimedia data by a control device. The control device utilizes directory data that describes multimedia objects as well as defining relations (e.g., hierarchical structures) between multimedia objects. The metadata may include information such as location of multimedia data files, descriptions and categorizations of multimedia objects, codecs, transfer protocols, custom user data, etc. The relational data may include container or collection definitions that group multimedia objects.

The present invention may utilize a mechanism that uses the existing UPnP AV framework to provide information used to trigger the synchronization of the metadata between a CDS and a UPnP AV control point. Additionally the CDS metadata can be stored/cached by the control point or device acting on behalf the control point so that the media files can be managed in a smart way depending on the location of the user (i.e. advanced search, context aware search, etc.). These synchronization mechanisms can also be used to automate a backup procedure for the media files in the home network.

Typically, the multimedia directory data is stored at one or more server elements of a network. The control device accesses the multimedia directory data from the server elements (e.g., the CDS of a media server) via the network. The control device caches the directory data locally in a data store. The user device and server element can synchronize the data through the use of system and object identifiers. The identifiers are unique references that allow the control device to determine whether changes have occurred on the server element's data as a whole. The identifiers may also be used to provide more fine-grained determination of changes, such as tracking the state of a multimedia object, container, or other relational data.

The identifier may include a specially formatted entry in the CDS that will store the “signature” of the media server. The media server will update this signature every time new entries are added, deleted or updated in the CDS. The signature can be represented as a simple counter that is incremented every time something has changed, a hash of the metadata or it can have more advanced meanings indicating also the nature of the change. Alternatively the CDS could define a new entry for synchronization or content summary/backup data and that entry could include: timestamp, signature, etc. The control points in such an arrangement will also store the unique ID of each CDS that the control point connects with.

Traditionally, consumer electronics devices have exchanged data using dedicated cables and electrical interfaces. For example, an audio/video (AV) receiver may have inputs for receiving any combination of analog composite video, analog audio, digital audio, analog component video, digital video, remote control signals, etc. Consumer devices typically connect to the AV receiver via cables, thus a typical entertainment center is clustered around a central location. With the increasing adoption of wireless home networking, the concept of requiring all devices to be connected to a central switching and control location such as an AV receiver is becoming antiquated. Digital networking technologies allow multimedia and other content to be accessed throughout the home. In some arrangements, the data can also be accessed remotely via long-distance access networks such as the Internet.

The desire to provide data distribution capabilities in a home environment has given rise to technologies such as the UPnP standard. UPnP was developed to allow easy interoperability between electronics devices in a local network such as a home network. The UPnP AV specification is an adaptation of UPnP that allows consumer electronics devices to distribute entertainment content throughout a home network. Although the present invention is described in relation to UPnP networks, it will be appreciated that the present invention may also be applicable to other technologies that allow digitally distributing entertainment content between devices. For example, the concepts described herein may be equally applicable to home automation technologies such as X-10, xAP, Jini, HomeRF, Bluetooth, IrDA, etc.

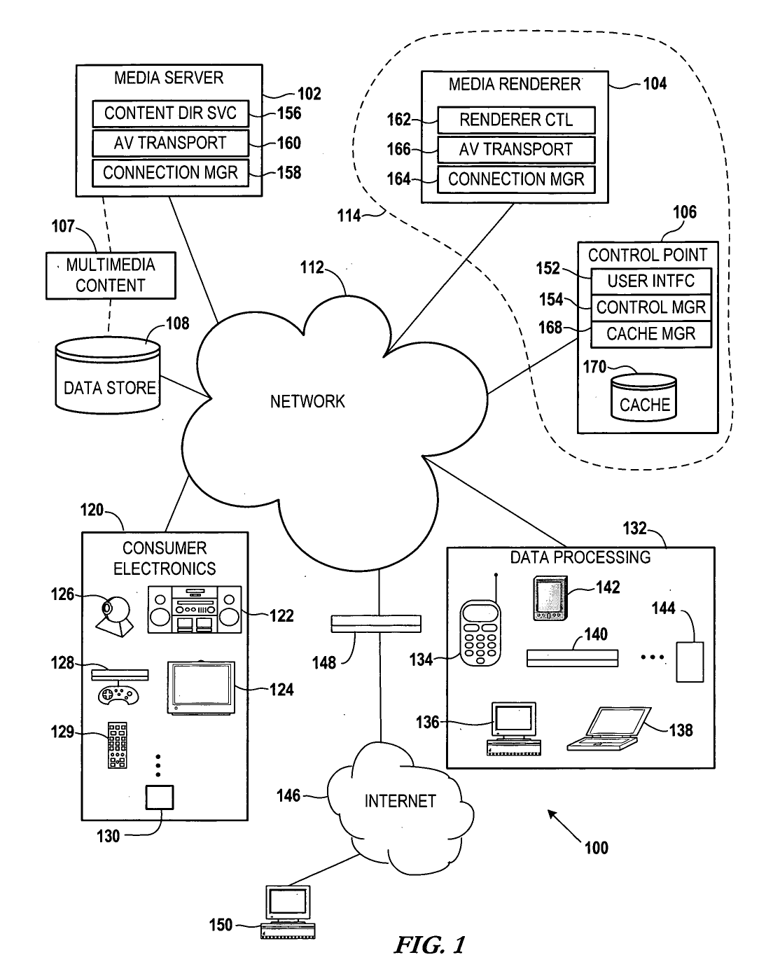

In reference now to FIG. 1, various entities of a UPnP AV architecture 100 are shown according to embodiments of the present invention. In particular, three logical entities of the UPnP architecture are shown: a media server 102, a media renderer 104, and a control point 106. The media server 102 has access to entertainment content 107 located in one or more data stores 108. The media server 102 can send the content 107 to another UPnP AV device, such as the media renderer 104, via a network 112. The media renderer 104 is able to receive multimedia content 107 from the network 112 and render the content 107 on its hardware interfaces. The control point 106 coordinates the operation of the media server 102 and media renderer 104 to perform actions desired by the end-user.

The media servers 102 and media renderer 104 implement a set of UPnP AV services. These services can be used by the control point 106 to transfer content from the server 102 to the renderer 104. The control point 106 is usually involved only in command and control operations in transferring data between the media server 102 and media renderer 104. These operations typically include identifying and selecting data, data transfer protocols, and data formats to be used for data transfer. The media server 102 and media renderer 104 will transfer the desired content using protocols and formats supported by both network elements 102, 104. Therefore, the control point 106 can be implemented independently of the protocols or data formats used by the server 102 and renderer 104.

The media server 102, media renderer 104, and control point 106 are logical entities defined in the UPnP AV architecture 100. Devices employed in the architecture 100 may include the functions of any combination of these entities 102, 104, 106. For example, a device may include both a media renderer 104 and an embedded control point 106 as indicated by the dashed line 114. Such a device 114 includes the capability to control operations from the same location where the content is rendered.

The UPnP architecture 100 is suitable for use by a wide range of electronic devices. For example, consumer electronic devices 120 may utilize the UPnP network 112. Consumer electronic devices 120 may include audio equipment 122, televisions 124, cameras 126, video games 128, infrared (IR) remote controls 129, or any other device traditionally associated with consumer entertainment, as represented by generic consumer electronic device 130.

Data processing devices 132 may also be utilized in the UPnP architecture 100. Data processing devices 132 generally provide computing or communications functions. Examples of data processing devices 132 include cellular phones 134, desktop computers 136, portable computers 138, routers 140, personal digital assistants (PDAs) 142, or any other device as represented by generic device 144. It will be appreciated that the distinction between consumer electronic devices 120 and data processing devices 132 is somewhat arbitrary, as most modern electronics include data processing functionality (e.g., embedded microprocessors) and most utility computing/communications devices have home-use applications.

The UPnP architecture 100 is generally utilized within a local environment such as a home or office. The architecture 100 may utilize any combination of wired and wireless network media and protocols. The networks and devices 120, 132 of the UPnP architecture 100 may also be made externally accessible via public data transmission mediums such as the Internet 146. For example, a UPnP gateway/router 148 may allow a remote device 150 to access to some or all of the elements of the UPnP network 112 via the Internet 146 or other publicly accessible medium (e.g., public airwaves).

Utilizing the AV capabilities of a UPnP AV network typically involves interactions between devices that serve one or more of the roles of the media server 102, media renderer 104, and control point 106. The logical functions of these entities 102, 104, 106 may be incorporated in the consumer electronics and data processing devices 120, 132 known in the art. For example, a PDA 142 can act as a control point 106 for selecting streaming video available from a computer 136 that acts as a media server 102. The streaming video could be directed to a television 124 which acts as a media renderer 104. Assuming all devices in the architecture 100 incorporate the UPnP standard uniformly, this type of interaction between devices can take place with only minimal setup and configuration by the user.

A particularly useful application of the UPnP AV technology involves the use of a wireless device (e.g., the cell phone 134) as a control point 106. Generally, these wireless devices 134 can be adapted to communicate over a variety of wireless networks and protocols, including 802.11 WLAN, Bluetooth, CDMA, TDMA, etc. The wireless device 134 is generally portable and battery powered, and is thus ideally suited as a control point 106 because the user is likely to carry the wireless device 134 for purposes such as receiving phone calls. Therefore a wireless device 134 that is capable of providing UPnP control 106 frees the user from having to search for specialized remote controls 129 or other apparatus. Also, the advanced display capabilities of modern cell phones 134 and similar devices are ideal for conveying the potentially complex user interface required by the control point 106.

A disadvantage of using a wireless device 134 as a control point 106 deals with the typically low bandwidth connections used by such devices. Although some wireless protocols (e.g., 802.11g) are providing ever-increasing bandwidth, most portable devices cannot utilize such bandwidth due, for example, to power transmission limitations. Therefore, a wireless device 134 used as a UPnP control point 106 will need to carefully limit the use of bandwidth when performing network communications. To better understand the issues of bandwidth usage of a UPnP control point 106, a more detailed discussion of how a control point 106 operates in the UPnP AV specification is presented.

The UPnP control point 106 generally controls data transfers between media servers 102 and media renderers 104. This may involve: locating the server 102 and renderer 104 devices on the network; enumerating the available content from the server 102; querying the server 102 and renderer 106 to determine common transfer protocols and data formats; configuring the server 102 and renderer 104 with the desired content and selected protocol and formats; initiating the transfer of the content; specifying adjustments to the content such as data rate, volume, etc. The control point 106 will typically include a user interface 152 for conveying directory information to the user and receiving commands from the user. A control manager 154 may be used to communicate between the user interface 152 and the server 102 and renderer 104 in order to perform the data transfer tasks desired by the user.

One task performed by the control point 106 involves querying the media server 102 to determine the content available on the server 102. The media server 102 has access to entertainment content 107 and can send that content 107 to another device for rendering. The media server 102 includes a content directory service (CDS) 156 that allows the control point 106 to discover and enumerate all of the server's content. The server 102 also includes a connection manager 158 that allows the control point 106 to negotiate and select the protocols and data format used when transferring content between the media server 102 and renderer 104. The server 102 may optionally include an AV transport service 160 is used to control the flow of the content (e.g., pause, fast-forward) during playback on the media renderer 104.

The media renderer 104 is configured to receive content 107 via the network 112 or other means (e.g., direct wired connections) and render the content 107. The content 107 can be rendered by any form of electrical device, including video displays, speakers, motors, heating/cooling elements, electro-chemical devices, switching devices, etc. The media renderer 104 includes a rendering control 162 that can be used to control how the content is rendered. The rendering control 162 may be used for changing parameters such as video brightness and sound volume. The media render 104 includes a connection manager 164 used to negotiate and select the protocols and data formats with the media server 102. Similar to the media server 102, the media renderer may include an AV transport service 166 is used to control content flow.

Of particular interest regarding bandwidth used by a wireless device 134 is the communication between the CDS 156 and the control point 106. The CDS 156 allows the control point 106 to discover and enumerate content 107 that is accessible by a media server 102. The content 107 available on the media server 102 is described in terms of “objects.” The CDS 156 provides metadata that describes various attributes of these objects. Metadata may include such as attributes as title, duration, creation time, modification time, etc.

When the control point 106 joins the network 112, it uses the Simple Service Discovery Protocol (SSDP) to find all of the media servers 102 and media renderers 104 in the network. All devices that implement media server and media renderer templates will respond to the request with a URL of the device's description document. Once media servers and renderers are located, the control point 106 obtains and parses the description documents to determine each device's exact capabilities.

After initialization, the control point 106 may use each media server's CDS 156 to enumerate the content that is available from the servers 102. Control points 106 may collect CDS 156 information from multiple servers and aggregate this information into a single view of all of the content that is available from a particular network 112. The CDS 156 utilizes the eXtensible Markup Language (XML) to describe objects and their associated properties. An object is any data entity that can be returned by a CDS from a browsing or searching action. A property represents a CDS 156 or client-defined characteristic of an object. The CDS 156 expresses properties in XML as either elements or attributes.

The CDS 156 utilizes a hierarchy of object classes. In particular, two high level classes of objects are “items” and “containers.” An item typically represents a unit of AV data, such as a CD track or a movie file. A container represents a collection of objects. Containers can contain both items and other containers. The CDS 156 forms XML documents that provide descriptions of these objects.

The CDS 156 is primarily “action” based, meaning certain predefined actions can be invoked from the control point 106, and the CDS 156 responds with data. The control point 106 may invoke at least two actions to discover objects from the CDS: “Browse” and “Search.” The CDS 156 supports at least the “Browse” action, and may optionally support the “Search” action. Browsing involves retrieving a list of data objects at an entry point (i.e., a container object) in the CDS directory structure. The Browse action may be represented by the function prototype “Browse(ObjectID, BrowseFlag, Filter, StartingIndex, RequestedCount).” The ObjectID refers to the ID of the object currently being browsed. The root container in the CDS 156 always has an ObjectID of “0.” If the BrowseFlag is set to “BrowseMetadata,” the CDS 156 will return the metadata associated with the ObjectID. If BrowseFlag is set to “BrowseDirectChildren,” the ObjectID refers to a container, and the CDS 156 will return a listing of metadata associated with the objects contained in the container.

The control point 106 can discover the entire content of the CDS 156 using the Browse actions starting at the root container. Any containers found as a result of this and subsequent actions are used as an entry point for subsequent Browse requests. In this way, a control point 106 can traverse the entire directory structure exposed by the CDS.

In response to the “Browse” action, the CDS 156 will return an XML fragment that describes the objects requested. The CDS 156 will also return values indicating the number of objects returned in the result, total number of objects in the container (if BrowseFlag is set to BrowseDirectChildren), and an UpdateID. The UpdateID is an identifier used by the CDS 156 to indicate a current state of a container. If the content or property of a container changes, its UpdateID is incremented. If the ObjectID is zero (i.e., the object is the root container), then the UpdateID returned is a special identifier known as the SystemUpdateID. The SystemUpdateID variable changes whenever anything in the CDS 156 directory changes.

The CDS 156 may optionally respond to a “Search” action. The Search is used to find a set of objects that match a particular search criteria. The CDS 156 can provide a list of properties on which it can search by responding to a GetSearchCapabilities action. As with the Browse action, the CDS 156 will return an XML fragment that describes the objects satisfying the search, if any are found.

After the control point 106 has obtained a list of objects from either a Browse or Search action, the control point 106 can display the results in the user interface 152. The user can select items from this interface 152 for further browsing or to select items for rendering. After the user selects the content to be rendered, the control point 106 retrieves the CDS 156 metadata for the selected items. This metadata is used to determine the supported transfer protocols and data formats. The control point 106 then compares this metadata with the data from the renderer's connection manager 164 to determine if the renderer 104 is capable of rendering the desired content.

After a common protocol/format has been identified, the control point 106 invokes the connection manager services 158, 164 on both the server 102 and renderer 104. Each device is informed of the target protocol/format, and the respective connection managers 158, 164 set up and configure a multimedia playback session based on the common protocol and format that was chosen.

The CDS 156 is primarily designed to allow the control point 106 to discover data accessible via the CDS 156. The control point 106 may rely entirely the CDS 156 to determine the current state of content on the media server 102. However, there may be situations when it is preferable to cache the CDS 156 data on the control point device 106. For example, the control point 106 may offer advanced searching capabilities that are not available via the CDS 156, such as context-aware searching. Also, the control point 106 can more quickly search a local cache rather than send a request to the CDS 156 over a low-bandwidth connection. The control point 106 can even browse the local cache when the completely disconnected from the network 112. In other situations, the control point 106 may have access to multiple CDS 156 servers that are not always accessible by the control point 106. Searching can be improved by restricting searches to only those CDSs available over the current network connection.

According to an embodiment of the present invention, the control point 106 contains a cache manager 168 and a cache 170 for storing object metadata received from the CDS 156. The cache 170 may be implemented on any form of volatile or non-volatile memory, including a hard drive, removable media, flash memory, random access memory (RAM), etc. The cache manager 168 is a software component that can automatically initiate actions (e.g., Browse) to retrieve object data from the CDS 156 and store that data in the cache 170. The cache manager 168 may also monitor CDS actions performed by the user interface 152 and control manager 154 to create a partial CDS cache and/or to update existing cache entries. The user interface 152 can display data and initiate actions such as searching via the cache manager 168 instead of via the control manager 154 and CDS 156.

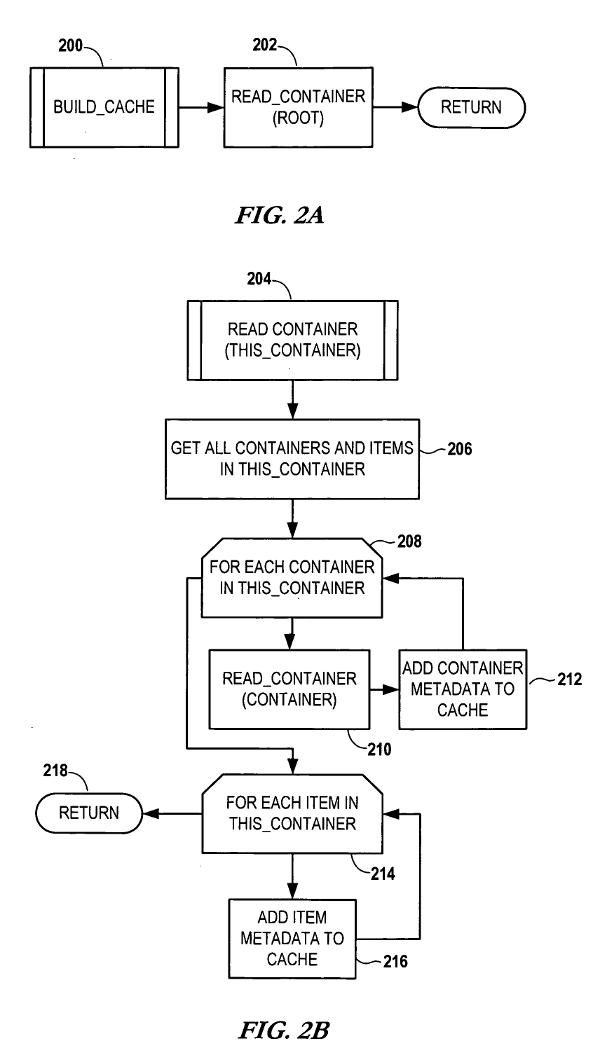

Upon first discovering a CDS 156 on a UPnP network, the control point 106 device may be configured to read and cache the entire CDS 156 data set. An example procedure for reading the CDS data into the cache 170 according to embodiments of the present invention is shown in FIGS. 2A and 2B. The Build_Cache routine 200 begins by calling 202 the Read_Container routine 204 shown in FIG. 2B with the root container as the argument. The Read_Container routine 204 begins by getting 206 all objects in This_Container, which is the argument passed into the routine 204. This step 206 may be performed, for example, by calling Browse with BrowseFlag of BrowseDirectChildren. A loop iterates 208 through the containers found in This_Container (if any), and Read_Container is recursively called 210 on each container found. The metadata for each container is added 212 to the cache after Read_Container 210 returns. Next, a loop iterates 214 through the items, and the metadata for each item is added 216 to the cache. After metadata for all containers and items have been added to the cache, the routine exits 218.

As an alternative to the routines shown in FIGS. 2A and 2B, a modification to the CDS interface may allow downloading the entire CDS directory structure in a single action. For example, the Browse action may be extended to allow downloading the entire CDS data set in a single invocation. This may be done by configuring the Browse action to support a BrowseFlag such as “BrowseAll.” A Browse action using the BrowseAll flag would return a document that lists the entire CDS metadata depository.

In reference again to FIG. 1, the cache 170 may be populated with some or all of the CDS data when first connected to the UPnP network 112. Once the cache 170 contains at least part of the CDS content, there must be a way to determine when entries in the CDS 156 have changed. It is important that the cache 170 and CDS 156 remain synchronized in order for the control point 106 to operate correctly. Currently, the CDS 156 maintains a SystemUpdateID that changes whenever any object tracked by the CDS 156 is added or removed, or when the metadata of an object changes. The CDS 156 provides an asynchronous event that informs system entities of the value of SystemUpdateID. Also, at any time clients entities can request the current value of SystemUpdateID by invoking a GetSystemUpdateID action at the CDS 156. This latter method may be used by clients to poll the CDS 156 for the current value of SystemUpdateID.

Typically, the control point 106 will locally store the content of every CDS that it encounters. When the control point 106 connects to a known CDS 156, the control point 106 will first read the “signature” entry (e.g., the SystemUpdateID). If the “signature” is different than the one that is cached in the control point 106, then the CDS content has changed and a synchronization procedure is triggered.

The CDS 156 is only required to modify the SystemUpdateID whenever a CDS object changes, but the way the SystemUpdateID is changed is not specified. The SystemUpdateID may be a counter that is incremented on each change, a hash of the metadata, or may be a value that is specially encoded to indicate the nature and extent of the change. One example of the last option is to set a bit of the SystemUpdateID to indicate that the last change did or did not involve a change to metadata. Similar bits could be used to indicate addition or deletion of objects, or other change types. In another implementation, some bits of the SystemUpdateID may be used to indicate of a portion the CDS directory tree in which the change occurred, thereby speeding up retrieval of the changed data.

Use of the SystemUpdateID gives a coarse-grained indication of changes within the CDS 156, because it only indicates that the CDS 156 has changed, but not what or where the change occurred. The CDS 156 may also provide a ContainerUpdateID that changes when the contents of a single container changes. The ContainerUpdateID can be sent out as an event by the CDS 156. The ContainerUpdateID events include a set of ordered pairs. Each ordered pair consists of “ContainerID, ContainerUpdateID.” The control point 106 can monitor the ContainerUpdateID events, retrieve the current container data through a Browse or Search, and use the retrieved data to update the cache 170.

The control point 106 can store these ContainerUpdateID and/or SystemUpdateID as a unique identifiers for each corresponding entry of the CDS 156. This enables the control point 106 to intelligently activate only those entries in the cache 107 that are actually available in the network. For example a user may have collections of music at home and at work. The user may want to use the same application and the same device to manage the music at these two locations. The work and home CDSs will have different unique IDs (e.g., SystemUpdateID), and the individual entries within the CDS will also have unique IDs (e.g., ContainerUpdateID). By tracking these unique IDs, the control point 106 is able to detect the location and activate the available entries for the user.

Generally, the control point 106 can poll a CDS 156 for changes in update IDs or listen to regular occurring update events. Although this tracking of update IDs is useful for a continually connected system, a mobile device 134 used as a control point 106 may only be intermittently connected with the CDS 156. Therefore, reliance on receiving update events will not guarantee that the cache 170 is synchronized if the control point 106 is disconnected from the network 112 for a given amount of time. In such a case, the control point 106 may just traverse the CDS directory upon re-connection and re-download all or some changed entries. However, this may consume large amounts of bandwidth and may not efficient if there were only minor changes to the CDS 156 while the control point 106 was disconnected.

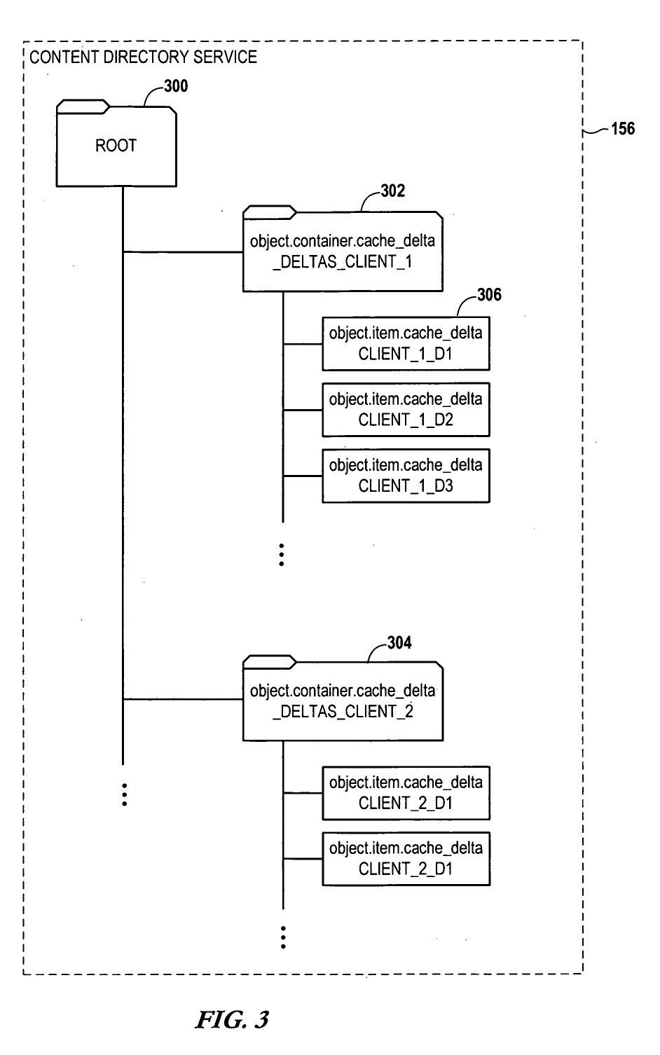

One solution for synchronizing the cache 170 of an intermittently connected control point 106 is to maintain a record of CDS 156 changes as part of the CDS directory service. One way of maintaining CDS changes according to an embodiment of the present invention is shown in FIG. 3. The CDS 156 can maintain a special class of containers that are stored under the root container 302. In this example, the containers are of a class object.container.cache_delta. The control point and other clients would be configured to ignore this type of container when presenting multimedia object data to the user. The control point without this synchronization feature will also ignore this entry because it is separated from the normal tree and this entry will not intercept the existing entries. The location of the cache_delta containers directly under the root container is arbitrary; any well-known location in the CDS directory structure would suffice. It will be appreciated that the media server will continually maintain these entries with the up to date information of the CDS tree.

In the illustrated example, two cache_delta containers 302, 304 are located under the root container 300. The containers 302, 304 are maintained for two clients, CLIENT_{—}1 and CLIENT_{—}2. The control points or other clients may be able to automatically create these directory structures through an action invoked on the CDS 156. Under each container is a list of objects of type object.item.cache_delta, e.g., item 306. In this example, the containers 302, 304 contain multiple cache_delta items. Each cache_delta may contain a record of a single change to the CDS directory. The control point or other client can look under their own cache_delta container, read the cache_delta items, and apply the changes listed in the cache_delta items to the client's local cache. The client may then delete the cache_delta items from the container. Other arrangements may involve flagging or otherwise marking the already examined entries for current or future deletion. In this way, the CDS 156 can provide clients with a list of changes without the clients having to traverse the entire CDS directory structure.

In another arrangement, the cache_delta directories 302, 304 may contain only a single file that is concatenated with changes. In this arrangement, a single file may be maintained for each client in the root container 300 or other well-known location in the CDS 156, thus eliminating the need for the special cache_delta containers 302, 304. In either arrangement, the cache_delta items would contain such data as timestamps, signatures, object IDs, nature of change, and other data needed to update a local cache.

Other variations on the arrangement shown in FIG. 3 include placing a “synchronization metadata” entry in the CDS 156. The synchronization metadata may include a unique ID similar to the SystemID, but would also include a signature or hash of all or part of the CDS 156. The synchronization metadata may also include other metadata that allows a control point to determine the nature of the changes, similar to a cache_delta item 306. The control point could include a “synchronization agent” that is configured to read this metadata and apply only those changes described in the metadata.

The CDS 156 might have multiple instance of this synchronization metadata entries depending on the synchronization protocol used by UPnP to perform the synchronization. For example, if the synchronization is done with SyncML there would be one entry including some metadata that SyncML requires. In another arrangement, a plurality of synchronization metadata entries may be maintained, each entry including an associated SystemID. If the SystemID is a counter, the control point could compare a cached value of the SystemID with the most recent value on the CDS 156. Updating the control point would involve incrementally reading and applying each synchronization metadata entry having associated id values that range between the old SystemID and the current SystemID. It will be appreciated that each CDS 156 in a multi-CDS system may utilize different synch protocols and this entry will include this information and other metadata necessary by those protocols.

The synchronization as described in the various examples above could be triggered by a user when doing a browse or search action, or it could be automatically triggered by a synchronization agent running on the device. The control point 106 could be configured in such a way that when being close to the media server 102, the control point 106 will automatically download all relevant data, and/or search in the object.container.cache_delta or other synchronization metadata. After the control point 106 has determined downloadable data is available from the CDS 156, the synchronization can be triggered automatically, or the control point 106 could prompt the user indicating there is new or modified data in the media server 102. The user may then browse to see the new content and initiate the synchronization.

A control point that regularly caches data will, in general, have a faster response during searches and system browsing. This is particularly true for wireless devices, which typically have lower bandwidth and higher latency than wired connections. Since a typical system changes only infrequently, the downloading and updating of the local cache will have minimum impact on bandwidth utilization.

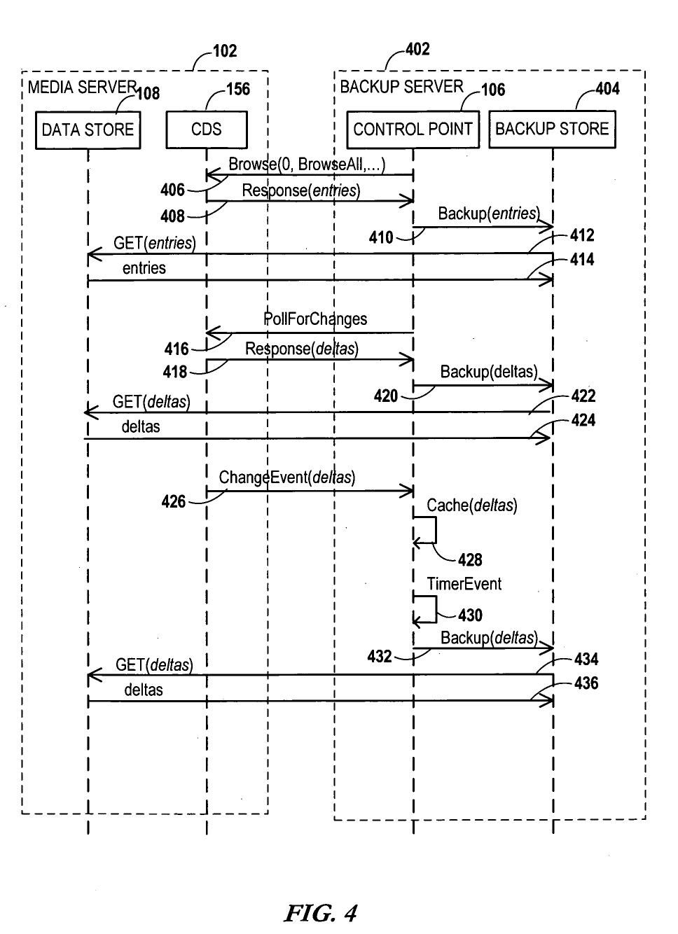

The tracking of CDS changes may be useful in other applications besides mobile control points. FIG. 4 illustrates a data backup scenario using cache update concepts according to embodiments of the present invention. In FIG. 4, a media server 102 contains a data store 108 and CDS 156 as previously described. A backup server 402 includes a control point 106 for interacting with the CDS 156. The backup server 402 functions to backup data from the media data store 108 onto a backup data store 404.

On first use, the control point 106 may need to determine the entire contents of the CDS 156. In this illustration, the control point 106 uses a Browse command 406 with the previously described BrowseAll extension. In response, the CDS 156 replies with the metadata for all entries 408 in the CDS data store 108. It will be appreciated that the same entries 408 can be obtained using a directory traversal as shown in FIGS. 2A and 2B, or any other method known in the art.

The control point 106 issues a backup command 410 to the backup data store 404 that includes all the entries that need to be retrieved for backup. The backup data store 404 initiates a retrieval 412 of the entries (e.g., FTP GET) and the entries are downloaded 414 from the media data store 108 to the backup data store 404. It will be appreciated that the data retrieved 414 may include any combination of CDS metadata and actual data objects (e.g., media files) stored on the media server 102 or elsewhere. Thereafter, the backup server 402 needs only to perform incremental backups.

Two scenarios for incremental backups are shown in FIG. 4. In the first scenario, the control point 106 actively polls 416 the CDS 156 for changes. This polling 156 may involve any combination of checking the SystemUpdateID, ContainerUpdateIDs, or using specialized caching data as described in relation to FIG. 3. If changes have occurred, a response 418 is used to determine the deltas. Similar to the full backup, the control point 106 commands 420 the backup data store 404 to backup files. However, this time only the deltas need to be backed up. As before, the data stores 404, 108 perform a retrieval request 422 and download 424 to immediately backup the data.

The next scenario in FIG. 4 uses asynchronous update events generated by the CDS 156. The CDS 156 regularly sends an event 426 that communicates any changes in the media data store 108. The control point 106 caches 428 only the deltas to an internal cache (e.g., cache 170 shown in FIG. 1). The backup server 402 in this scenario is configured to perform backups during a certain time, such as late at night when the network is likely to be inactive. Therefore, at the predetermined time, the control point 106 responds to an internally generated timer event 430 and initiates a backup request 432, which results in a data retrieval request 434 and a download of incremental data 436. It will be appreciated that the full and incremental backups shown in FIG. 4 may use any combination of CDS polling and CDS events to determine backup data, as well as any combination of immediate backup and timer event backup.

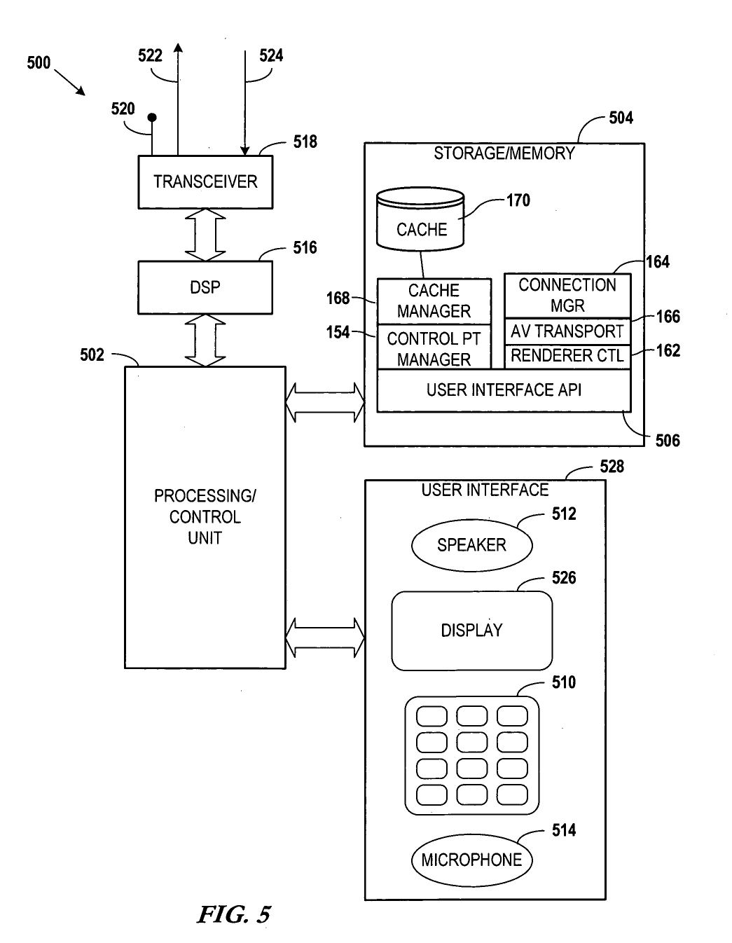

The UPnP standard is flexible enough to allow many types of apparatus to perform roles as media server, media renderer, and control point. Mobile devices are particularly useful as control points, and may also be used as media renderers. In reference now to FIG. 5, an example is illustrated of a representative mobile computing arrangement 500 capable of carrying out operations in accordance with embodiments of the invention. Those skilled in the art will appreciate that the exemplary mobile computing arrangement 500 is merely representative of general functions that may be associated with such mobile devices, and also that landline computing systems similarly include computing circuitry to perform such operations.

The illustrated mobile computing arrangement 500 is suitable for performing roles as both a media renderer and a control point in a UPnP AV network. The mobile computing arrangement 500 includes a processing/control unit 502, such as a microprocessor, reduced instruction set computer (RISC), or other central processing module. The processing unit 502 need not be a single device, and may include one or more processors. For example, the processing unit may include a master processor and associated slave processors coupled to communicate with the master processor.

The processing unit 502 controls the basic functions of the arrangement 500. Those functions associated may be included as instructions stored in a program storage/memory 504. In one embodiment of the invention, the program modules associated with the storage/memory 504 are stored in non-volatile electrically-erasable, programmable read-only memory (EEPROM), flash read-only memory (ROM), etc. so that the information is not lost upon power down of the mobile terminal. The relevant software for carrying out conventional mobile terminal operations and operations in accordance with the present invention may also be transmitted to the mobile computing arrangement 500 via data signals, such as being downloaded electronically via one or more networks, such as the Internet and an intermediate wireless network(s).

The program storage/memory 504 may also include operating systems for carrying out functions and applications associated with functions on the mobile computing arrangement 500. The program storage 504 may include one or more of read-only memory (ROM), flash ROM, programmable and/or erasable ROM, random access memory (RAM), subscriber interface module (SIM), wireless interface module (WIM), smart card, hard drive, or other removable memory device.

For performing control point functions, the program storage/memory 504 includes a control point manager 154, a cache manager 168, and a cache 170. The control point manager 154 interfaces with a user interface application program interface (API) 506 for displaying media server metadata and for receiving user selections for controlling UPnP multimedia services. To perform media rendering functions, the program storage/memory 504 contains a connection manager 164, an AV transport module 166, and a renderer control 162. The renderer control 162 also interfaces with the UI API 506 in order to render output to physical devices such as displays and speakers.

The mobile computing arrangement 500 includes hardware and software components coupled to the processing/control unit 502 for performing network data exchanges. The mobile computing arrangement 500 may include multiple network interfaces for maintaining any combination of wired or wireless data connections. In particular, the illustrated mobile computing arrangement 500 includes wireless data transmission circuitry for performing network data exchanges.

This wireless circuitry includes a digital signal processor (DSP) 516 employed to perform a variety of functions, including analog-to-digital (A/D) conversion, digital-to-analog (D/A) conversion, speech coding/decoding, encryption/decryption, error detection and correction, bit stream translation, filtering, etc. A transceiver 518, generally coupled to an antenna 520, transmits the outgoing radio signals 522 and receives the incoming radio signals 524 associated with the wireless device.

The processor 502 is also coupled to user-interface 528 elements associated with the mobile terminal. The user-interface 528 of the mobile terminal may include, for example, a display 526 such as a liquid crystal display, a keypad 510, speaker 512, and microphone 514. These and other user-interface components are coupled to the processor 502 as is known in the art. Other user-interface mechanisms may be employed, such as voice commands, switches, touch pad/screen, graphical user interface using a pointing device, trackball, joystick, or any other user interface mechanism.

The mobile computing arrangement 500 of FIG. 5 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

Hardware, firmware, software or a combination thereof may be used to perform the various functions and operations described herein. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a system, apparatus, and method in accordance with the present invention.

The foregoing description of the exemplary embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather defined by the claims appended hereto.

What is claimed is:

1. A method of synchronizing content description data between devices on an ad hoc peer-to-peer network, comprising:
storing a plurality of data entries on a directory server, each data entry describing one or more multimedia data objects accessible via the network;
associating a synchronization object of the directory server with the data entries, the synchronization object capable of describing changes to the data entries;
downloading the data entries from the directory server to a cache of a control point device via the network;
changing the synchronization object of the directory server in response to a change in at least one of the data entries of the directory server; and
updating the cache of the control point device with the change in the at least one data entry based on the changing of the synchronization object of the directory server.

2. The method of claim 1, further comprising modifying the synchronization object to reflect the updating of the cache of the control point device.

3. The method of claim 1, wherein the synchronization object includes a hash of the data entries.

4. The method of claim 1, wherein the synchronization object is capable of describing a change in at least one of time stamp and signature associated with the multimedia data objects.

5. The method of claim 1, wherein the synchronization object is capable of describing the addition and deletion of an entry of the plurality of data entries.

6. The method of claim 1, wherein changing the synchronization object of the directory server in response to the change in at least one of the data entries of the directory server comprises adding data to the synchronization object, wherein the data describes the change in the at least one data entry.

7. The method of claim 1, wherein changing the synchronization object of the directory server in response to the change in at least one of the data entries of the directory server comprises:
creating a new synchronization object that describes the change; and
associating the new synchronization object with the entries.

8. The method of claim 7, wherein updating the cache of the control point device comprises examining a plurality of new synchronization objects that were added after a previous update of the cache and before the current update of the cache.

9. An apparatus, comprising:
a network interface capable of communicating with a directory server via an ad hoc peer-to-peer network;
a processor coupled to the network interface; and
a memory coupled to the processor, the memory including,
a cache capable of storing data;
a control point module having instructions that cause the processor to,
download a plurality of data entries from the directory server to the cache via the network, each data entry describing one or more multimedia data objects accessible via the network;
access, via the network, a synchronization object of the directory server associated with the data entries of the directory server, the synchronization object capable of describing changes to the data entries;
detect a change in the synchronization object of the directory server, the change occurring in response to a change in at least one of the data entries of the directory server; and
update the cache with the change in the at least one data entry based on the changing of the synchronization object of the directory server.

10. The apparatus of claim 9, wherein the control point module further causes the processor to modify the synchronization object of the directory server to reflect the updating of the cache.

11. The apparatus of claim 9, wherein the synchronization object includes a hash of the data entries associated with the synchronization object.

12. The apparatus of claim 9, wherein the synchronization object is capable of describing a change in metadata associated with the multimedia objects.

13. The apparatus of claim 9, wherein the synchronization object is capable of describing the addition and deletion of an entry of the plurality of data entries.

14. The apparatus of claim 9, wherein detecting the change in the synchronization object comprises detecting data added data to the synchronization object, wherein the data describes the change in the at least one data entry.

15. The apparatus of claim 9, wherein detecting the change in the synchronization object comprises detecting the creation of a new synchronization object of the directory server that describes the change.

16. The apparatus of claim 15, wherein updating the cache comprises examining a plurality of new synchronization objects of the directory server that were added after a previous update of the cache and before the current update of the cache.

17. A computer-readable medium having instructions stored thereon which are executable by a data processing arrangement capable of being coupled to an ad hoc peer-to-peer network for performing steps comprising:
downloading a plurality of data entries from a directory server to a cache of the data processing arrangement via the network, each data entry describing one or more multimedia data objects accessible via the network;
accessing, via the network, a synchronization object of the directory server associated with at least one of the data entries of the directory server;
detecting a change in the synchronization object of the directory server, the change occurring in response to a change in at least one of the data entries of the directory server associated with the synchronization object; and
updating the cache with the change in the at least one data entry based on the changing of the synchronization object of the directory server.

18. The computer-readable medium of claim 17, wherein the steps further comprise modifying the synchronization object of the directory server to reflect the updating of the cache.

19. The computer-readable medium of claim 17, wherein the synchronization object comprises a hash of the data entries associated with the synchronization object.

20. The computer-readable medium of claim 17, wherein the synchronization object is capable of describing a change in metadata associated with the multimedia objects.

21. The computer-readable medium of claim 17, wherein the synchronization object is capable of describing the addition and deletion of an entry of the plurality of data entries.

22. The computer-readable medium of claim 17, wherein detecting the change in the synchronization object comprises detecting data added data to the synchronization object, wherein the data describes the change in the at least one data entry.

23. The computer-readable medium of claim 17, wherein detecting the change in the synchronization object comprises detecting the creation of a new synchronization object of the directory server that describes the change.

24. The computer-readable medium of claim 23, wherein updating the cache comprises examining a plurality of new synchronization objects of the directory server that were added after a previous update of the cache and before the current update of the cache.

25. An apparatus, comprising:
a network interface capable of communicating via an ad hoc peer-to-peer network;
a processor coupled to the network interface; and
a memory coupled to the processor, the memory including a directory service module having instructions that cause the processor to,
store a plurality of data entries, each data entry describing one or more multimedia data objects that are accessible by a network entity via the network;
communicate the data entries to the network entity;
associate a synchronization object with the data entries, the synchronization object capable of describing changes to the data entries;
change the synchronization object in response to a change in at least one of the data entries associated with the synchronization object; and
communicate the change in the synchronization object to the network entity so that the network entity is able to update a cache of the data entries based on the change in the synchronization object.

26. The apparatus of claim 25, wherein the directory service module further causes the processor to allow the network entity to modify the synchronization object to reflect updates made to the cache of the network entity.

27. The apparatus of claim 25, wherein the synchronization object includes a hash of the data entries associated with the synchronization object.

28. The apparatus of claim 25, wherein the synchronization object is capable of describing a change in metadata associated with the multimedia objects.

29. The apparatus of claim 25, wherein the synchronization object is capable of describing the addition and deletion of an entry of the plurality of data entries.

30. The apparatus of claim 25, wherein changing the synchronization object comprises adding data to the synchronization object, wherein the data describes the change in the at least one data entry.

31. The apparatus of claim 25, wherein changing the synchronization object comprises:
creating a new synchronization object that describes the change; and
associating the new synchronization object with the data entries.

32. A computer-readable medium having instructions stored thereon which are executable by a data processing arrangement capable of being coupled to an ad hoc, peer-to-peer network for performing steps comprising:
storing a plurality of data entries, each data entry describing one or more multimedia data objects that are accessible by a network entity via the network;
communicating the data entries to the network entity;
storing a synchronization object capable of describing changes to the data entries;
changing the synchronization object in response to a change in at least one of the data entries; and
communicating the change in the synchronization object to the network entity so that the network entity is able to update a cache of the data entries based on the change in the synchronization object.

33. The computer-readable medium of claim 32, wherein the steps further comprise modifying the synchronization object to reflect updates made to the cache of the network entity.

34. The computer-readable medium of claim 32, wherein the synchronization object comprises a hash of the data entries associated with the synchronization object.

35. The computer-readable medium of claim 32, wherein the synchronization object is capable of describing a change in metadata associated with the multimedia objects.

36. The computer-readable medium of claim 32, wherein the synchronization object is capable of describing the addition and deletion of an entry of the plurality of data entries.

37. The computer-readable medium of claim 32, wherein changing the synchronization object comprises adding data to the synchronization object, wherein the data describes the change in the at least one data entry.

38. The computer-readable medium of claim 32, wherein changing the synchronization object comprises:
creating a new synchronization object that describes the change; and
associating the new synchronization object with the data entries.

39. A system comprising:
an ad hoc, peer-to-peer network;
a directory server coupled to the network and configured to,
store a plurality of data entries on a data store, each data entry describing one or more multimedia data objects accessible via the network;
associate a synchronization object of the directory server with the data entries; and
change the synchronization object of the directory server in response to a change the data entries; and
a control point coupled to the network and configured to,
download the plurality of data entries from the directory server to a cache of the control point;
detect the change in the synchronization object of the directory server; and
update the cache with the change in the at least one data entry based on the changing of the synchronization object of the directory server.

40. The system of claim 39, wherein the control point is further configured to modify the synchronization object to reflect the updating of the cache.

41. The system of claim 39, wherein the synchronization object includes a hash of the data entries.

42. An apparatus comprising:
means for storing a plurality of data entries downloaded from a directory server, each data entry describing one or more multimedia data objects accessible via a network;
means for accessing a synchronization object of the directory server associated with the data entries of the directory server, the synchronization object capable of describing changes to the data entries of the directory server;
means for detecting a change in the synchronization object of the directory server, the change occurring in response to a change in at least one of the data entries of the directory server; and
means for updating the data entries stored on the apparatus with the change in the at least one data entry based on the changing of the synchronization object of the directory server.

43. An apparatus comprising:
means for storing a plurality of data entries, each data entry describing one or more multimedia data objects that are accessible by a network entity;
means for communicating the data entries to the network entity;
means for storing a synchronization object capable of describing changes to the data entries;
means for changing the synchronization object in response to a change in at least one of the data entries associated with the synchronization object; and
means for communicating the change in the synchronization object to the network entity so that the network entity is able to update a cache of the data entries stored on the network entity.

44. A method of controlling the disposition of multimedia data between devices on a network, comprising:
storing a plurality of data entries on a directory server, each data entry describing one or more multimedia data objects accessible via the network;
associating a unique ID of the directory server with at least one of the data entries;
downloading the data entries from the directory server to a cache of a mobile terminal via the network;
changing the unique ID of the directory server in response to a change in at least one of the data entries associated with the unique ID;
retrieving from the directory server one or more data objects that describe the change in the at least one data entry;
updating the cache of the mobile terminal with the change in the at least one data entry based on the one or more data objects.
